(19) United States
(12) Patent Application Publication
(10) Pub. No.: US 2017/0364814 A1
(43) Pub. Date: Dec. 21, 2017

(54) SYSTEM AND METHOD FOR ASSESSING CHARACTERISTICS OF WEB SITES

(71) Applicant: Symantec Corporation, Mountiain View, CA (US)

(72) Inventor: Michael D. Rinehart, San Jose, CA (US)

(21) Appl. No.: 15/186,023

(22) Filed: Jun. 17, 2016

(51) Int. Cl. G06N 5/04; G06N 99/00

(52) U.S. Cl. CPC G06N 5/04; G06N 99/005

(57) ABSTRACT

According to one embodiment, a method for assessing whether a first site possesses a selected characteristic, the method comprising training, using a machine-learning process, a classifier to determine, based on web site data corresponding to one or more known web sites, whether the first web site possesses the selected characteristic, wherein the one or more known web pages comprise web pages known to possess the selected characteristic and web pages known not to possess the selected characteristic.

### TECHNICAL FIELD

This disclosure relates in general to web sites and more particularly to a system and method for assessing the characteristics of web sites.

### BACKGROUND

Web sites may have various characteristics such as abilities and/or restrictions. For example, a web site may have various security related characteristics such as encryption or secure login. In some fields, such as IT or security compliance, it may be beneficial to know the characteristics of a web site in order to develop or update security standards or to detect when unauthorized web sites are being accessed.

### SUMMARY OF THE DISCLOSURE

According to one embodiment, a method for assessing whether a first site possesses a selected characteristic, the method comprising training, using a machine-learning process, a classifier to determine, based on web site data corresponding to one or more known web sites, whether the first web site possesses the selected characteristic, wherein the one or more known web pages comprise web pages known to possess the selected characteristic and web pages known not to possess the selected characteristic.

Certain embodiments may provide one or more technical advantages. For example, an embodiment of the present disclosure may automatically assess the characteristics of unknown web sites thereby reducing the cost associated with the manual review and analysis web site characteristics. As another example, an embodiment of the present disclosure may result a more accurate assessment of the characteristics of a web site. Other technical advantages will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present disclosure and its advantages, reference is now made to the following description, taken in conjunction with the accompanying drawings, in which:

FIG. 1 is a block diagram illustrating a system for training a classifier and assessing the characteristics of an unknown web site based on the classifier, according to certain embodiments;

FIG. 2 is a flow chart illustrating a method for training and applying a classifier using the system of FIG. 1, according to one embodiment of the present disclosure;

FIG. 3 is a flow chart illustrating additional details of the step of training a classifier in FIG. 2, according to one embodiment of the present disclosure; and

FIG. 4 illustrates an example computer system that may be used for certain components configured to perform the methods of FIGS. 2 and 3, according to certain embodiments of the present disclosure.

### DETAILED DESCRIPTION OF THE DISCLOSURE

Knowing the characteristics of a web site may be important to ensure IT and security compliance of users of an organization. For example, there may be a data-loss risk when users of an organization access and use a file-sharing site that is not sanctioned by the IT department of the organization. Although the characteristics of popular or well-established file sharing sites may be known, new file sharing sites are constantly being created, updated, or changed. Because of this, researchers are hired to manually analyze client-server transactions to identify file-sharing sites and to determine the characteristics of the identified sites. In addition to being costly, manual identification of characteristics may be troublesome because the site itself may not clearly state whether the site has the particular characteristic. As used herein, a characteristic refers to a capability or restriction of a web site.

The teachings of the disclosure recognize training and applying a classifier to automatically assess whether an unknown web site has a particular characteristic. The following describes systems and methods of classifying and assessing the characteristics of web sites for providing these and other desired features.

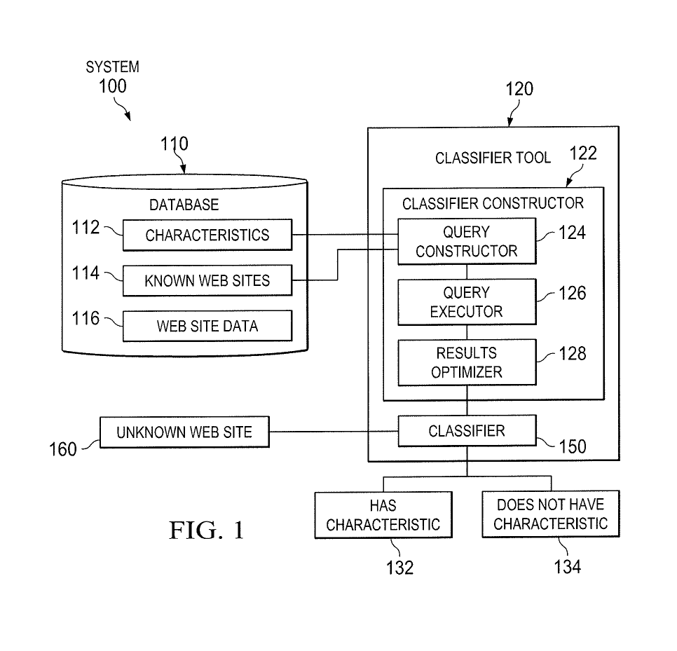

FIG. 1 illustrates a system 100 for training a classifier 150 in order to assess whether an unknown web site 160 has a particular characteristic. System 100 may include a database 110 and a classifier tool 120. In some embodiments, classifier tool 120 is a program that may be stored and executed by a computer system such as computer system 400 depicted in FIG. 4.

In general, classifier tool 120 trains a classifier 150 in some embodiments to identify features indicative of a particular characteristic of a web site based on data collected from web sites known to have, or known not to have, the characteristic. Classifier tool 120 may also determine whether an unknown web site has a particular characteristic based on the trained classifier.

Database 110 may include a plurality of characteristics of web sites 112 and identities of one or more known web sites 114. The identities of one or more known web sites 114 may include the identities of web sites known to have one or more characteristics of the plurality of characteristics 112 and the identities of web sites known to not have one or more characteristics of the plurality characteristics 112. The identity of a web site may be a name of an organization, a link to an organization's web site, a logo, or any other suitable item from which a web site may be identifiable. In some embodiments, database 110 also includes web site data 116 about the known web sites 114.

The plurality of characteristics 112 may comprise capabilities or restrictions of a web site. Encrypt-at-rest and secure login may be examples of capabilities of a web site. An example of a restriction of a web site may be whether the site may be used commercially. Although specific characteristics of web sites have been described, this disclosure recognizes any suitable characteristic of a web site that may be assessed in the training of classifier 150. Further, although this disclosure describes using a classifier to assess the capabilities or restrictions of a web site, this disclosure recognizes assessing the capabilities or restrictions of any online service such as a cloud application.

Database 110 may also identify a plurality of known web sites 114 that are known to have, or known not to have particular characteristics. For example, database 110 may include the following information from TABLE 1 below:

TABLE 1

| | Characteristics | | |
|---|---|---|---|
| Web site | Encrypt-at-Rest | Secure Login | Commercial Use |
| Site #1 | Yes | Yes | Yes |
| Site #2 | Yes | Yes | No |
| Site #3 | No | Yes | No |

TABLE 1 above includes information regarding whether a web site possesses a particular characteristic of a plurality of characteristics 112. According to TABLE 1, Site #1 has the characteristics of encrypt-at-rest, secure login, and commercial use. Site #2 possesses the characteristics encrypt-at-rest and secure login; However site #2 does not possess the commercial use characteristic (i.e., has a restriction against using the site for commercial use). According to TABLE 1, Site #3 does not include the characteristics of encrypt-at-rest or commercial use, but does possess the secure login characteristic.

Database 110 may also include data 116 about the plurality known web sites 114. In some embodiments, database 110 is pre-loaded with web site data 116. In other embodiments, web site data 116 is saved to database 110 in response to an instruction from classifier tool 120. For example, classifier tool 120 may store web site data 116 resulting from constructing a classifier 150 in database 110. In some embodiments, data 116 is indicative of whether one or more of the known web sites 114 has one or more of the plurality of characteristics 112. Data 116 may include the web site HTML/Javascript or the web site text. Data 116 may also include results data such as links, summary information, and text ripped from web sites. Data 116 may be received from a tailored web search, from trusted external sites, and text from a site related to the web site in interest. Although specific sources of data have been described, this disclosure recognizes that database 110 may include any data 116 (including metadata) about the plurality of known web sites 114 from any source.

Classifier tool 120 may include a classifier constructor 122 in some embodiments. Classifier constructor 122 may be configured to construct a classifier 150 based on data 116 collected from one or more known web sites 114. Classifier constructor 122 may include a query constructor 124, a query executor 126, and a results optimizer 128 in some embodiments. Although this disclosure describes and depicts query constructor 124 and query executor 126 as being components of classifier constructor 122, this disclosure recognizes that in some embodiments, query constructor 124 and query executor 126 may comprise its own tool having logic that is operable when executed to construct and execute searches regarding characteristics of web sites 114. In some embodiments, such a tool may also be configured to store web site data 116 to database 110. For example, such tool may yield the pre-loaded web site data 116 described above.

Query constructor 124 may be configured to construct one or more queries based on one or more selected characteristics of the plurality of characteristics 112 and the identities of one or more of known web sites 114. For example, TABLE 2 below depicts four separate queries about the characteristic “encrypt at rest” that may be constructed by query constructor 124:

TABLE 2

| QUERY | Characteristic: Encrypt-at-Rest |
|---|---|
| QUERY #1 | “Encrypts Data at rest [SITE NAME]” |
| QUERY #2 | “Encrypts Data at rest site: [SITE DOMAIN]” |
| QUERY #3 | Encryption [SITE NAME] |
| QUERY #4 | Encryption site: [SITE DOMAIN]” |

Query constructor 124 may construct any suitable number of queries. For example, query constructor 124 may construct a single query regarding a single characteristic and apply it to the identities of one or more of known web sites 114. Alternatively, query constructor 124 may construct a plurality of queries related to a single characteristic and apply each query to the identities of one or more of known web sites 114. In some embodiments, classifier constructor 122 constructs classifier 150 by combining all the results of all executed queries. Classifier constructor 122 may construct an ensemble classifier in some embodiments. An ensemble classifier may be constructed by first constructing a classifier for each query and then using the outputs of the classifiers to construct a new classifier (i.e., a classifier composed of layers of classifiers). This disclosure recognizes certain benefits of using an ensemble classifier. For example, an ensemble classifier may more accurately assess characteristics of a web site.

Query constructor 124 may construct a plurality of queries that will yield positive data in some embodiments. In other embodiments, query constructor 124 may construct a plurality of queries that will yield negative data. As used herein, “positive data” refers to data about one or more web sites known to possess the selected characteristic, and “negative data” refers to data about one or more web sites known to not possess the selected characteristic.

As depicted in FIG. 1, classifier tool 120 may include a query executor 126. Query executor 126 may be configured to execute the queries constructed by query constructor 124. In some embodiments, query executor 126 executes the queries via a web search engine (e.g., Google, Yahoo, Bing, etc.). The resulting data may be stored as web site data 116 in database 110. In other embodiments, query executor 126 executes the queries against web site data 116 previously stored in database 110.

Classifier tool 120 may also include results optimizer 128 in some embodiments. In some embodiments, results optimizer 128 may be configured to optimize the results from the executed query. For example, in some embodiments, results optimizer 128 may be configured to filter the results for relevancy. Taking the example QUERIES 1-4 in TABLE 2 above, classifier tool 120 may determine that the results returned from executing certain queries are irrelevant or unrelated or untrustworthy. For example, the results returned from executing QUERY 3 may include the term “encryption” but not in conjunction with the name of the web site. As another example, the results returned from executing QUERY 3 may include the name of the web site but not in conjunction with the term “encryption.” As yet another example, the results returned from executing QUERY 3 may include an internet forum addressing the issue of whether the at-issue web site has the encryption characteristic, however classifier tool 120 may determine that the internet forum is not a trustworthy source of information. Although specific examples of reasons to filter results have been described, this disclosure contemplates filtering the results for any suitable reason. Filtration of results (or, in other words, optimization of the results) may be associated with certain advantages such as constructing a more precise classifier and/or increased accuracy in determining whether an unknown web site, such as unknown web site 160 of FIG. 1, possesses the selected characteristic. In some embodiments, classifier tool 120 stores only the relevant web site data 166 in database 110.

Classifier tool 120 may be configured to identify one or more features indicative of the selected characteristic. In some embodiments, features are identified based on positive results. For example, classifier tool 120 may identify text within the results of the executed query that is indicative of a web site possessing the characteristic “encrypt at rest.” In other embodiments, features are identified based on negative results. For example, classifier tool 120 may identify text within the results of an executed query that is indicative of a web site not possessing the selected characteristic.

Features indicative of a particular characteristic may be determined by any suitable means. In some embodiments, classifier tool 120 determines combinations of words and text that are strongly related to, or highly predictive of, the selected characteristic. For example, in some embodiments, a feature may be determined by analyzing the relevant data for the “Top 100” words appearing within a particular data set (e.g., results of a single query or results of more than one query). The “Top 100” may be determined by counts, metrics, or any other suitable method. By determining the “Top 100” words, classifier tool 120 may determine features common to web sites known to possess the selected characteristic, or, alternatively, features common to web sites known not to possess the selected characteristic.

As another example, classifier tool 120 may determine one or more features by determining whether the resulting data includes the selected characteristic and site name or URL across a single site, within a certain number of characters or distance, and/or within the same sentence, and/or the same row/column of a table. Although specific methods of determining features have been described, this disclosure recognizes using any suitable method to detect features indicative of whether a web site possesses, or does not possess, a selected characteristic.

Classifier constructor 122 may be configured to construct a classifier, such as classifier 150 depicted in FIG. 1, based on the features identified by classifier tool 120. Thus, classifier 150 may be constructed based on the features most indicative of the selected characteristic. In some embodiments, classifier constructor 122 may construct a single classifier 150. In other embodiments, classifier constructor 122 may construct more than one classifier 150. For example, classifier constructor 122 may construct a first classifier 150 based on positive data and a second classifier 150 based on negative data.

Classifier 150 may be constructed based on a machine learning algorithm (e.g., Logistic Regression, Decision Tree Trainer, etc.) in some embodiments. In other embodiments, classifier 150 is constructed based on a formula. One having ordinary skill the in the art will understand how one or more classifiers 150 may be created from one or more sets of data. For example, each query structure may be associated with a formula and that each formula may yield an output based on the results of the queries. The outputs of each formula may be used to create another formula that comprises the classifier.

Classifier Tool 120 may be configured to determine whether an unknown web site, such as unknown web site 160 of FIG. 1, possesses a particular characteristic. In some embodiments, classifier 150 is used to determine whether unknown web site 160 possesses a particular characteristic. Determining whether unknown web site 160 possesses a particular characteristic may comprise determining an output value. In some embodiments, the output value corresponds to a confidence of classifier tool 120 that unknown web site 160 possesses or does not possess the selected characteristic. For example, if the output of classifier 150 is in the range of 0-0.1, classifier tool 120 may be confident that unknown web site 160 does not have the characteristic. If the output of classifier 150 is in the range of 0.1-0.3, classifier tool 120 may have a low confidence that unknown web site 160 does not have the characteristic. In the event that the output of classifier 150 falls between 0.3-0.7, classifier tool 120 may determine that it is not confident whether unknown web site 160 has the selected characteristic. However, if the output of classifier 150 is 0.9-1.0, classifier tool 120 may determine that it is confident that unknown web site 160 has the selected characteristic.

Classifier Tool 120 may also be configured to detect problems with system 100. For example, classifier tool 120 may apply a first classifier 150 to an unknown web site 160, wherein the first classifier 150 is based on features indicative that the web site possesses a selected characteristic. If the output of classifier tool 120 is high (e.g., output is 0.9 on a 0.0-1.0 scale), it may indicate that classifier tool 120 is fairly confident that unknown web site 160 possesses the selected characteristic. However, in a subsequent application, classifier tool 120 may apply a second classifier 150 to unknown web site 160, wherein the second classifier 150 is based on features indicative that the web site does not possess the selected characteristic. If this output is also high (e.g., output is 0.9 on a 0.0-1.0 scale), it may indicate that classifier 150 has been trained improperly or that there is a problem with system 100. Alternatively, if the output of classifier 150 is low (e.g., output is 0.0 on a 0.0-1.0 scale), it may indicate that classifier 150 is working properly and that unknown web site 160 may be confidently classified as possessing the selected characteristic.

Classifier tool 120 may be further configured to classify one or more unknown web sites 160 as possessing, or not possessing, the selected characteristic. As depicted in FIG. 1, classifier tool 120 may classify unknown web site 160 as having the selected characteristic 132 or classify unknown web site 160 as not having the selected characteristic 134. In some embodiments, classifier tool 120 may be unable to classify unknown web site 160 as having, or not having, the selected characteristic (e.g., when classifier 150 is both 50% confident that unknown web site 160 has the selected characteristic 134 and 50% confident that unknown web site 160 does not have the selected characteristic 134). In some embodiments, in response to classifying unknown web site 160 as being positive or negative (having or not having the characteristic), classifier tool 120 may cause database 110 to be updated. For example, in response to determining that Unknown Website #1 possesses the selected characteristic, known web sites 114 of database 110 is updated to reflect that unknown web site 160 is now known. Similarly, web site data 116 of database 110 may be updated with any data associated with unknown web site 160 that resulted from the determination that unknown web site 160 possessed the selected characteristic. In this way, classifier tool 120 may rely on feedback from previous classifications to fine tune system 100, thereby increasing the reliability and accuracy of subsequent classifications. In some embodiments, prior to updating database 110, newly classified web sites and any data resulting from executed queries may be stored in a repository for manual review to ensure that classifier 150 has classified unknown web site 160 correctly. After confirming the classification, in some embodiments, database 110 may be updated with the confirmed classification.

In operation, classifier tool 120 receives a selected characteristic of a plurality of characteristics 112 and the identities of one or more known web sites 114 from database 110 that are associated with the selected characteristic. In some embodiments, the known web sites 114 comprise web sites known to possess the selected characteristic and web sites known to not possess the selected characteristic. Query constructor 124 constructs a plurality of queries relating the plurality of known web sites 124 to the selected characteristic. In some embodiments, query constructor 124 may construct a query relating each web site of the one or more known web sites 114 to the selected characteristic. For example, query constructor 124 may construct a query relating each of the web sites known to have the selected characteristic to the selected characteristic. As another example, query constructor 124 may construct a query relating each of the web sites known not to have the selected characteristic to the selected characteristic. In some embodiments, the query constructed by query constructor 124 is executed by query executor 126. As detailed above, query executor 126 may execute the queries in a search engine which yields resulting data. In response to receiving results from the executed query, the results may be optimized by results optimizer 128 in some embodiments. Classifier tool 120 may identify features that are suggestive, predictive, or indicative of the selected characteristic and, after determining the indicative features, classifier constructor 122 may construct classifier 150.

Herein, a constructed classifier is also referred to as a trained classifier. The trained classifier 150 may be used by classifier tool 120 to determine whether unknown web site 160 possesses the selected characteristic. As described above, the output of classifier 150 may be an output value indicating a confidence of classifier tool 120. In some embodiments, classifier tool 120 classifies unknown web site 160 as possessing the selected characteristic 132 or not possessing the characteristic 134. In some other embodiments, classifier tool 120 may flag the unknown web site 160 for manual review (e.g., if the output value is 0.5 (50%) indicating that classifier tool 120 is unable to determine whether it is more likely than not that unknown web site 160 possesses the selected characteristic).

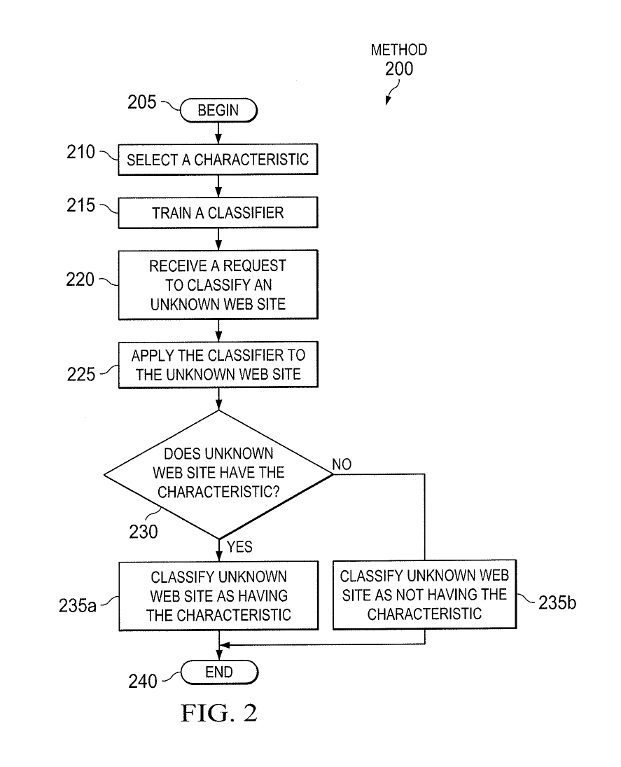

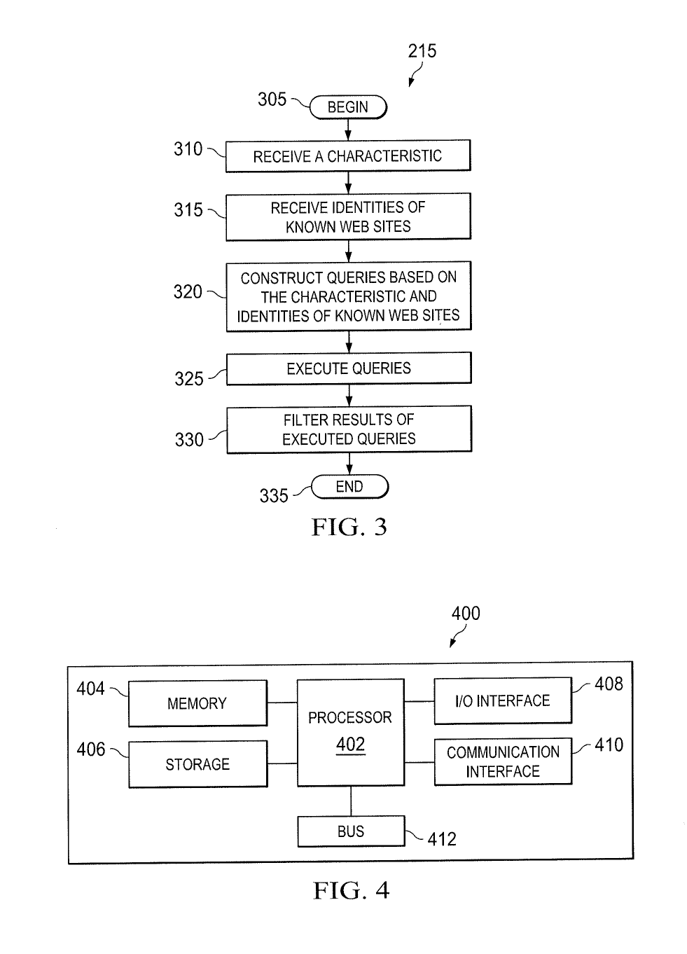

Generally, classifier tool 120 trains a classifier 150 and uses the trained classifier to assess the characteristics of web sites. In some embodiments, classifier tool 120 operates according to a method 200 described below in reference to FIG. 2. FIG. 2 is a flow chart illustrating a method for training and applying a classifier, such as classifier 150 of FIG. 1. FIG. 3 is a flow chart illustrating additional detail of certain steps of FIG. 2, and FIG. 4 shows an example computer system that may be used for certain components of system 100 or in the methods of FIGS. 2 and 3.

The method 200 may begin in a step 205. At a step 210, classifier tool 120 selects a characteristic. In some embodiments, a characteristic is selected from the plurality of characteristics 112 stored in database 110. In some other embodiments, a characteristic is selected from the plurality of characteristics 112 in response to receiving a request to analyze a selected characteristic. The plurality of characteristics 112 may be characteristics that a web site may or may not possess. For example, characteristics of a web site may include capabilities and/or restrictions of a web site. In some embodiments, the method 200 may continue to a step 215.

At step 215, classifier tool 120 trains a classifier 150. In some embodiments, classifier 150 is trained using a machine-learning process (e.g., an algorithm or formula). In some embodiments, training classifier 150 includes identifying features indicative of the selected characteristic based on data associated with a plurality of web sites that are known to possess the selected characteristic and a plurality of web sites that are known to not possess the selected characteristic. Training a classifier is described in more detail below in reference to FIG. 3. In some embodiments, the method 200 continues to a step 220.

At step 220, classifier tool 120 receives a request to assess the characteristics of an unknown web site. For example, the unknown web site could be unknown web site 160 depicted in FIG. 1. In some embodiments, a web site is deemed unknown if it is not one of the known web sites 114 in database 110. In some embodiments, the method 200 continues to a step 225.

At step 225, classifier tool 120 applies classifier 150 to unknown web site 160. In some embodiments, applying classifier 150 includes constructing queries based on features identified as indicative of the selected characteristic. In some embodiments, the method 200 continues to a decision step 230.

At decision step 230, classifier tool 120 determines whether unknown web site 160 possesses or does not possess the selected characteristic. In some embodiments, determining that the unknown web site 160 possesses or does not possess the selected characteristic is based on an output value. In some embodiments, the output value represents a confidence that unknown web site 160 possesses or does not possesses the selected characteristic. If classifier tool 120 determines that unknown web site 160 possesses the selected characteristic, the method 200 may continue to a step 235a. Alternatively, if classifier tool 120 determines that unknown web site 160 does not possess the selected characteristic, the method 200 may continue to a step 235.

At step 235, classifier tool classifies unknown web site 160 as possessing the selected characteristic (235a) or not possessing the selected characteristic (235b). In some embodiments, classifying unknown web site as possessing or not possessing the selected characteristic comprises saving an identity or identifier for unknown web site 160 in a particular group (e.g., groups 132 or 134 of FIG. 1). After a determination is made about whether unknown web site 160 possesses the selected characteristic, database 110 may be updated in some embodiments. For example, in response to determining that WEB SITE #1 does not possess the capability to encrypt at rest, known web sites 114 of database 110 may be updated. In some embodiments, any data generated as a result of determining whether unknown web site 160 has the selected characteristic is saved to web site data 116 of database 110. In this way, classifier tool 120 may generate feedback and is self-improving. As described above, in some embodiments, classifications are manually reviewed to ensure accuracy of the classification. In some embodiments, the method 200 may continue to an end step 240.

FIG. 3 is a flow chart illustrating additional details of training a classifier 150. Thus, the method of FIG. 3 depicts step 215 of FIG. 2. The method 300 may begin in a step 305. At a step 310, classifier tool 120 may receive a characteristic. In some embodiments, the received characteristic is received in response to a request to train a classifier 150 on a selected characteristic. In some embodiments, the characteristic is received from database 110. The received characteristic may be one of a plurality of characteristics 112 stored in database 110. In some embodiments, the method 300 continues to a step 315.

At step 315, classifier tool 120 may receive the identities of one or more known web sites 114. Known web sites 114 may be web sites known to possess, or known not to possess, the received characteristic. For example, classifier tool 120 may receive the identities of a plurality of positive web sites, wherein a positive web site is a web site known to possess the received characteristic. Classifier tool 120 may also receive the identities of a plurality of negative web sites, wherein a negative web site is a web site known to not possess the received characteristic.

At step 320, classifier tool 120 may construct one or more queries based on the received characteristic of step 310 and the received identities of known web sites 114 of step 315. In some embodiments, the queries are constructed to relate each of the known web sites 114 to the received characteristic. For example, database 110 may include three web sites known to have the secure login capability. Upon receiving that information, classifier tool 120 may construct a query relating the “secure login” characteristic to each of the three web sites known to possess this capability. This example is illustrated in TABLE 3 below:

TABLE 3
Web sites with “Secure Login”: Site 1, Site 4, Site 17

| | |
|---|---|
| QUERY Construct 1: | “secure login [SITE NAME]” |
| Constructed Queries | “secure login Site 1” |
| | “secure login Site 4” |
| | “secure login Site 17” |

In some embodiments, classifier tool 120 may construct a plurality of queries relating a particular characteristic to each identification of the one or more known web sites 114. For example, TABLE 4 below illustrates an example of constructing a plurality of queries relating to a particular characteristic for web sites known to possess the secure login capability:

TABLE 4
Web sites with “Secure Login”: Site 1, Site 4, Site 17

| | |
|---|---|
| QUERY Construct 1: | “secure login [SITE NAME]” |
| QUERY Construct 2: | “secure login site: [SITE DOMAIN]” |
| QUERY Construct 3: | “password login [SITE NAME]” |
| Constructed Queries | “secure login Site 1” |
| | “secure login Site 4” |
| | “secure login Site 17” |
| | “secure login site: www.sitel.com” |
| | “secure login site: www.site4.com” |
| | “secure login site: www.site17.com” |
| | “password login Site 1” |
| | “password login Site 4” |
| | “password login Site 17” |

Classifier tool 120 may construct any number of queries suitable to yield reliable results. In some embodiments, classifier tool 120 may construct queries relating a selected characteristic to positive web sites (web sites known to have the characteristic) (see e.g., TABLE 4 above). In other embodiments, classifier tool 120 may construct queries relating a particular characteristic to negative web sites (web sites known to not have the characteristic). In yet other embodiments, classifier tool 120 constructs queries relating a particular characteristic to both positive web sites and negative web sites. In some embodiments, queries may be optimized. Queries may be optimized using any known method including logistic regression, sparse optimization, L1-Regularization, recursive feature selection, and/or recursive feature reduction. In some embodiments, the method 300 continues to a step 325.

At step 325, classifier tool 120 executes the constructed queries. In some embodiments, classifier tool 120 executes the constructed queries using a web browser (e.g., Google, Yahoo, Bing, etc.). In other embodiments, classifier tool 120 executes the constructed queries against stored web site data (e.g., web site data 116 stored in database 110). In some embodiments, the method 300 continues to a step 330; in other embodiments, the method 300 may continue to a step 335.

At step 330, classifier tool 120 filters the data resulting from the executed queries for relevancy. Analyzing the resulting data for relevancy may be beneficial because some data returned from the executed queries may be irrelevant. Filtering the resulting data to include only that which is relevant may result in a classifier 150 that is more precise and therefore be more accurate in determining whether an unknown site has a particular characteristic. Relevancy of the data may be based on any number of things including presence of a web site name to the selected characteristic across a site, within a certain number of characters or distances, or within the same sentence or row or column of a table. Although this disclosure describes specific ways of filtering the stored data to include only relevant data, this disclosure recognizes using any suitable method of refining the data that results in an improved data set comprising only relevant data. In some embodiments, the method 300 continues to a step 335.

At step 335, classifier tool 120 identifies features indicative of the received characteristic. Features indicative of the received characteristic may be determined from the data returned from the one or more executed query searches. Features may be determined using any characterization of the text within the data set.

The method 300 may also comprise one or more data saving steps in some embodiments. For example, the method 300 may include an optional step wherein classifier tool 120 causes the data resulting from the executed queries to be saved. In some embodiments, the resulting data is saved to database 110. Resulting data may include text from a known web site, text from a web search, information from trusted sites about the known web site, etc. In some embodiments, all resulting data from the executed queries may be saved. In other embodiments, only the relevant resulting one or more computer systems 400 data is saved (e.g., the filtered data resulting from step 330). In some embodiments, the method 300 continues to an end step 340.

FIG. 4 illustrates an example computer system 400 configured to execute classifier tool 120. In particular embodiments, one or more computer systems 400 perform one or more steps of one or more methods described or illustrated herein. In particular embodiments, one or more computer systems 400 provide functionality described or illustrated herein. In particular embodiments, software running on one or more computer systems 400 performs one or more steps of one or more methods described or illustrated herein or provides functionality described or illustrated herein. Particular embodiments include one or more portions of one or more computer systems 400. Herein, reference to a computer system may encompass a computing device, and vice versa, where appropriate. Moreover, reference to a computer system may encompass one or more computer systems, where appropriate.

This disclosure contemplates any suitable number of computer system 400. This disclosure contemplates Computer system 400 taking any suitable physical form. As example and not by way of limitation, Computer system 400 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, Computer system 400 may include one or more computer systems 400; be unitary or distributed; span multiple locations; span multiple machines; span multiple data centers; or reside in a cloud, which may include one or more cloud components in one or more networks. Where appropriate, one or more computer systems 400 may perform without substantial spatial or temporal limitation one or more steps of one or more methods described or illustrated herein. As an example and not by way of limitation, one or more computer systems 400 may perform in real time or in batch mode one or more steps of one or more methods described or illustrated herein. One or more computer systems 400 may perform at different times or at different locations one or more steps of one or more methods described or illustrated herein, where appropriate.

In particular embodiments, Computer system 400 includes a processor 402, memory 404, storage 406, an input/output (I/O) interface 408, a communication interface 410, and a bus 412. Although this disclosure describes and illustrates a particular computer system having a particular number of particular components in a particular arrangement, this disclosure contemplates any suitable computer system having any suitable number of any suitable components in any suitable arrangement.

Processor 402 may include hardware for executing instructions, such as those making up a computer program. In some embodiments, processor 402 executes method 200. As an example and not by way of limitation, to execute instructions, processor 402 may retrieve (or fetch) the instructions from an internal register, an internal cache, memory 404, or storage 406; decode and execute them; and then write one or more results to an internal register, an internal cache, memory 404, or storage 406. In particular embodiments, processor 402 may include one or more internal caches for data, instructions, or addresses. This disclosure contemplates processor 402 including any suitable number of any suitable internal caches, where appropriate. As an example and not by way of limitation, processor 402 may include one or more instruction caches, one or more data caches, and one or more translation lookaside buffers (TLBs). Instructions in the instruction caches may be copies of instructions in memory 404 or storage 406, and the instruction caches may speed up retrieval of those instructions by processor 402. Data in the data caches may be copies of data in memory 404 or storage 406 for instructions executing at processor 402 to operate on; the results of previous instructions executed at processor 402 for access by subsequent instructions executing at processor 402 or for writing to memory 404 or storage 406; or other suitable data. The data caches may speed up read or write operations by processor 402. The TLBs may speed up virtual-address translation for processor 402. In particular embodiments, processor 402 may include one or more internal registers for data, instructions, or addresses. This disclosure contemplates processor 402 including any suitable number of any suitable internal registers, where appropriate. Where appropriate, processor 402 may include one or more arithmetic logic units (ALUs); be a multi-core processor; or include one or more processors 402. Although this disclosure describes and illustrates a particular processor, this disclosure contemplates any suitable processor.

In particular embodiments, memory 404 includes main memory for storing instructions for processor 402 to execute or data for processor 402 to operate on. As an example and not by way of limitation, Computer system 400 may load instructions from storage 406 or another source (such as, for example, another Computer system 400) to memory 404. Processor 402 may then load the instructions from memory 404 to an internal register or internal cache. To execute the instructions, processor 402 may retrieve the instructions from the internal register or internal cache and decode them. During or after execution of the instructions, processor 402 may write one or more results (which may be intermediate or final results) to the internal register or internal cache. Processor 402 may then write one or more of those results to memory 404. In particular embodiments, processor 402 executes only instructions in one or more internal registers or internal caches or in memory 404 (as opposed to storage 406 or elsewhere) and operates only on data in one or more internal registers or internal caches or in memory 404 (as opposed to storage 406 or elsewhere). One or more memory buses (which may each include an address bus and a data bus) may couple processor 402 to memory 404. Bus 412 may include one or more memory buses, as described below. In particular embodiments, one or more memory management units (MMUs) reside between processor 402 and memory 404 and facilitate accesses to memory 404 requested by processor 402. In particular embodiments, memory 404 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 404 may include one or more memories 404, where appropriate. Although this disclosure describes and illustrates particular memory, this disclosure contemplates any suitable memory.

In particular embodiments, storage 406 includes mass storage for data or instructions. As an example and not by way of limitation, storage 406 may include a hard disk drive (HDD), a floppy disk drive, flash memory, an optical disc, a magneto-optical disc, magnetic tape, or a Universal Serial Bus (USB) drive or a combination of two or more of these. Storage 406 may include removable or non-removable (or fixed) media, where appropriate. Storage 406 may be internal or external to Computer system 400, where appropriate. In particular embodiments, storage 406 is non-volatile, solid-state memory. In particular embodiments, storage 406 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 406 taking any suitable physical form. Storage 406 may include one or more storage control units facilitating communication between processor 402 and storage 406, where appropriate. Where appropriate, storage 406 may include one or more storages 406. Although this disclosure describes and illustrates particular storage, this disclosure contemplates any suitable storage.

In particular embodiments, I/O interface 408 includes hardware, software, or both, providing one or more interfaces for communication between Computer system 400 and one or more I/O devices. Computer system 400 may include one or more of these I/O devices, where appropriate. One or more of these I/O devices may enable communication between a person and Computer system 400. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 408 for them. Where appropriate, I/O interface 408 may include one or more device or software drivers enabling processor 402 to drive one or more of these I/O devices. I/O interface 408 may include one or more I/O interfaces 408, where appropriate. Although this disclosure describes and illustrates a particular I/O interface, this disclosure contemplates any suitable I/O interface.

In particular embodiments, communication interface 410 includes hardware, software, or both providing one or more interfaces for communication (such as, for example, packet-based communication) between Computer system 400 and one or more other computer system 400 or one or more networks. As an example and not by way of limitation, communication interface 410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 410 for it. As an example and not by way of limitation, Computer system 400 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, Computer system 400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 400 may include any suitable communication interface 410 for any of these networks, where appropriate. Communication interface 410 may include one or more communication interfaces 410, where appropriate. Although this disclosure describes and illustrates a particular communication interface, this disclosure contemplates any suitable communication interface.

In particular embodiments, bus 412 includes hardware, software, or both coupling components of Computer system 400 to each other. As an example and not by way of limitation, bus 412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 412 may include one or more buses 412, where appropriate. Although this disclosure describes and illustrates a particular bus, this disclosure contemplates any suitable bus or interconnect.

The components of computer system 400 may be integrated or separated. In some embodiments, components of computer system 400 may each be housed within a single chassis. The operations of computer system 400 may be performed by more, fewer, or other components. Additionally, operations of computer system 400 may be performed using any suitable logic that may comprise software, hardware, other logic, or any suitable combination of the preceding.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A system for determining whether a first web site possesses a selected characteristic, the system comprising:
a database comprising:
a plurality of characteristics of web sites, wherein the selected characteristic is one of the plurality of characteristics;
identifiers of one or more known web sites, wherein the one or more known web sites comprise web sites known to possess the selected characteristic and web sites known to not possess the selected characteristic; and
web site data corresponding to the one or more known web sites; and
a processor configured to:
train a classifier to determine, based on the web site data corresponding to the one or more known web pages, whether the first web site possesses the selected characteristic of the plurality of characteristics;
apply the classifier to a first web site; and
determine whether the first web site possesses the selected characteristic.

2. The system of claim 1, wherein the processor is further configured to:
construct a plurality of queries relating the one or more known web sites to the selected characteristic;
execute the plurality of constructed queries;
receive data relating the one or more known web sites to the selected characteristic in response to executing the plurality of constructed queries; and
construct a classifier based on the received data.

3. The system of claim 1, wherein the selected characteristic is a capability or restriction of a web site.

4. The system of claim 1, wherein the processor is further configured to:
update the classifier based on a determination that the first web site possesses, or does not possess, the selected characteristic; and
determining that a second web site possesses, or does not possess, the selected characteristic based on the updated classifier.

5. The system of claim 2, wherein the processor is further configured to filter the received data for relevancy.

6. The system of claim 1, wherein the processor determines whether the first web site possesses the selected characteristic based on an output value.

7. The system of claim 6, wherein the output value corresponds to a confidence that the first web site possesses, or does not possess, the selected characteristic.

8. A method for use in assessing whether a first web site possesses a selected characteristic, the method comprising:
training, using a machine-learning process, a classifier to determine, based on web site data corresponding to one or more known web sites, whether the first web site possesses the selected characteristic, wherein the one or more known web pages comprise web pages known to possess the selected characteristic and web pages known not to possess the selected characteristic.

9. The method of claim 8, further comprising:
applying the classifier to the first web site; and
in response to applying the classifier, determining whether the first web site possesses the selected characteristic.

10. The method of claim 8, wherein training a classifier comprises:
constructing a plurality of queries relating the one or more known web sites to the selected characteristic;
executing the plurality of constructed queries;
receiving data relating the one or more known web sites to the selected characteristic in response to executing the plurality of constructed queries; and
constructing a classifier based on the received data.

11. The method of claim 8, wherein the selected characteristic is a capability or a restriction of a web site.

12. The method of 9, further comprising:
updating the classifier based on a determination that the first web site possesses, or does not possess, the selected characteristic; and
determining that a second web site possesses, or does not possess, the selected characteristic based on the updated classifier.

13. The method of claim 10, further comprising filtering the received data for relevancy.

14. The method of claim 8, wherein determining whether the first web site possesses the selected characteristic is based on an output value, the output value corresponding to a confidence that the first web site possesses, or does not possess, the selected characteristic.

15. One or more computer-readable non-transitory storage media in or more computing system, the media embodying logic that is operable when executed to:
train a classifier to determine, based on web site data corresponding to one or more known web sites, whether a first web site possesses a selected characteristic of a plurality of characteristics, wherein the one or more known web sites comprise web sites known to possess the selected characteristic and web sites known not to possess the selected characteristic.

16. The media of claim 15, wherein the logic is further operable to:
apply the classifier to a first web site; and
determine whether the first web site possesses the selected characteristic.

17. The media of claim 15, wherein the logic is further operable to:
construct a plurality of queries relating the one or more known web sites to the selected characteristic;
execute the plurality of constructed queries;
receive data relating the one or more known web sites to the selected characteristic in response to executing the plurality of constructed queries; and
construct a classifier based on the received data.

18. The media of claim 15, wherein the selected characteristic is a capability or a restriction of a web site.

19. The media of claim 15, wherein the logic is further operable to:
update the classifier based on a determination that the first web site possesses, or does not possess, the selected characteristic; and
determining that a second web site possesses, or does not possess, the selected characteristic based on the updated classifier.

20. The media of claim 16, wherein the logic is further operable to filter the received data for relevancy.
